(19) United States
(12) Patent Application Publication
(10) Pub. No.: US 2008/0165388 A1
(43) Pub. Date: Jul. 10, 2008

(54) Automatic Content Creation and Processing

(76) Inventor: Bertrand Serlet, Palo Alto, CA (US)

Correspondence Address: FISH & RICHARDSON P.C., PO BOX 1022, MINNEAPOLIS, MN, 55440-1022, US

(21) Appl. No.: 11/619,998

(22) Filed: Jan. 4, 2007

(51) Int. Cl. H04N 1/40

(52) U.S. Cl. 358/448

(57) ABSTRACT

Content is created automatically by applying operations (e.g., transitions, effects) to one or more content streams (e.g., audio, video, application output). The number and types of operations, and the location in the new content where the operations are applied, can be determined by event data associated with the one or more content streams.

### RELATED APPLICATIONS

This application is related to U.S. patent application Ser. No. 11/462,610, for “Automated Content Capture and Processing,” filed Aug. 4, 2006, which patent application is incorporated by reference herein in its entirety.

### TECHNICAL FIELD

The subject matter of this patent application is generally related to content creation and processing.

### BACKGROUND

A “podcast” is a media file that can be distributed by, for example, subscription over a network (e.g., the Internet) for playback on computers and other devices. A podcast can be distinguished from other digital audio formats by its ability to be downloaded (e.g., automatically) using software that is capable of reading feed formats, such as Rich Site Summary (RSS) or Atom. Media files that contain video content are also referred to as “video podcasts.” As used herein, the term “podcast” includes multimedia files containing any content types (e.g., video, audio, graphics, PDF, text). The term “media file” includes multimedia files.

To create a conventional podcast, a content provider makes a media file (e.g., a QuickTime® movie, MP3) available on the Internet or other network by, for example, posting the media file on a publicly available webserver. An aggregator, podcatcher or podcast receiver is used by a subscriber to determine the location of the podcast and to download (e.g., automatically) the podcast to the subscriber's computer or device. The downloaded podcast can then be played, replayed or archived on a variety of devices (e.g., televisions, set-top boxes, media centers, mobile phones, media players/recorders).

Podcasts of classroom lectures and other presentations typically require manual editing to switch the focus between the video feed of the instructor and the slides (or other contents) being presented. A podcast can be manually edited using a content editing application to create more interesting content using transitions and effects. While content editing applications work well for professional or semi-professional video editing, lay people may find such applications overwhelming and difficult to use. Some subscribers may not have the time or desire to learn how to manually edit a podcast. In a school or enterprise where many presentations take place daily, editing podcasts require a dedicated person, which can be prohibitive.

### SUMMARY

In some implementations, a camera feed (e.g., a video stream) of a presenter can be automatically merged with one or more outputs of a presentation application (e.g., Keynote® or PowerPoint®) to form an entertaining and dynamic podcast that lets the viewer watch the presenter's slides as well as the presenter. Content can be created automatically by, for example, applying operations (e.g., transitions, effects) to one or more content streams (e.g., audio, video, application output). The number and types of operations, and the location in the new content where the operations are applied, can be determined by event data associated with the one or more content streams.

In some implementations, a method includes: receiving a number of content streams and event data; and automatically performing an operation on a content stream using the event data.

In some implementations, a method includes: receiving content streams; detecting an event in one or more of the content streams; aggregating edit data associated with the detected event; applying the edit data to at least one content stream; and combining the content streams into one or more media files.

In some implementations, a method includes: processing a first content stream for display as a background; processing a second content stream for display in a picture in picture window overlying the background; and switching the first and second content streams in response to event data associated with the first or second content streams.

In some implementations, a system includes a capture system configurable for capturing one or more content streams and event data. A processor is coupled to the capture system for automatically applying an operation on a content stream based on the event data.

In some implementations, a method of creating a podcast includes: receiving a number of content streams; and automatically generating a podcast from two or more of the content streams based on event data associated with at least one of the content streams.

In some implementations, a system includes a capture system operable for receiving a video or audio output and an application output. A processor is coupled to the capture system and operable for automatically performing an operation on at least one of the outputs using the event data.

In some implementations, a method of creating a podcast includes: receiving a number of content streams; and automatically generating a podcast from two or more of the content streams based on event data associated with at least one of the content streams.

In some implementations, a computer-readable medium includes instructions, which, when executed by a processor, causes the processor to perform operations including: providing a user interface for presentation on a display device; receiving first input through the user interface specifying the automatic creation of a podcast; and automatically creating the podcast in response to the first input.

In some implementations, a method includes: providing a user interface for presentation on a display device; receiving first input through the user interface specifying the automatic creation of a podcast; and automatically creating the podcast in response to the first input.

In some implementations, a method includes: identifying a number of related content streams; identifying event data associated with at least one content stream; and automatically creating a podcast from at least two content streams using the event data.

Other implementations of automated content creation and processing are disclosed, including implementations directed to systems, methods, apparatuses, computer-readable mediums and user interfaces.

### DESCRIPTION OF DRAWINGS

FIG. 1 is a block diagram illustrating an exemplary automated content capture and processing system.

FIG. 2 is a block diagram illustrating an exemplary automated content creation system.

FIG. 3 is a block diagram illustrating an exemplary event detector.

FIGS. 4A and 4B are flow diagrams of exemplary automated content creation processes.

FIG. 5 is a block diagram of an exemplary web syndication server architecture.

FIG. 6 illustrates a processing operation for generating new content that is initiated by a trigger event.

### DETAILED DESCRIPTION

### Automated Content Capture & Processing System

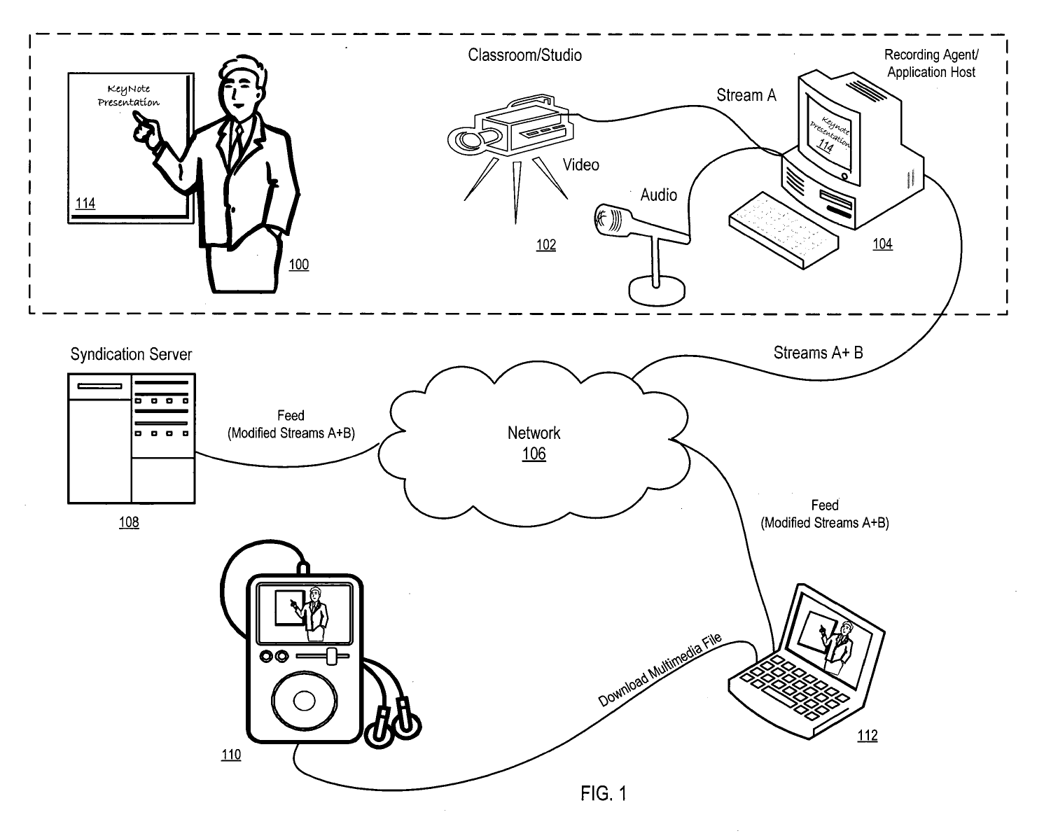

FIG. 1 is a block diagram illustrating an exemplary automated content capture and processing system. In some implementations, content is captured using a capture system 102 and a recording agent 104. Content can include audio, video, images, digital content, computer outputs, PDFs, text and metadata associated with content.

In the example shown, an instructor 100 is giving a lecture in a classroom or studio using an application 114. Examples of applications 114 include, without limitation, Keynote® (Apple Computer, Inc., Cupertino, Calif.) and PowerPoint® (Microsoft Corporation, Redmond, Wash.). In some implementations, the capture system 102 can include one or more of the following components: a video camera or webcam, a microphone (separate or integrated with the camera or webcam), a mixer, audio/visual equipment (e.g., a projector), etc. The capture system 102 provides a video stream (Stream A) and an application stream (Stream B) to the recording agent 104. Other streams can be generated by other devices or applications and captured by the system 102.

In some implementations, the recording agent 104 can reside on a personal computer (e.g., Mac Mini®) or other device, including without limitation, a laptop, portable electronic device, mobile phone, personal digital assistant or any other device capable of sending and receiving data. The recording agent 104 can be in the classroom or studio with the presenter and/or in a remote location. The recording agent 104 can be a software application for dynamically capturing content and event data for automatically initiating one or more operations (e.g., adding transitions, effects, titles, audio, narration). An exemplary recording agent 104 is described in co-pending U.S. patent application Ser. No. 11/462,610, for “Automated Content Capture and Processing.”

In the example shown, the recording agent 104 combines audio/video content and associated metadata (Stream A) with an application stream generated by the application 114 (Stream B). The Streams A and B can be combined or mixed together and sent to a syndication server 108 through a network 106 (e.g., the Internet, wireless network, private network).

The syndication server 108 can include an automated content creation application that applies one or more operations on the Streams A and/or B to create new content. Operations can include, but are not limited to: transitions, effects, titles, graphics, audio, narration, avatars, animations, Ken Burns effect, etc.

In some implementations, the operations described above can be performed in the recording agent 104, the syndication server 108 or both.

In some implementations, the syndication server 108 creates and transmits a podcast of the new content which can be made available to subscribing devices through a feed (e.g., an RSS feed). In the example shown, a computer 112 receives the feed from the network 106. Once received, the podcast can be stored on the computer 112 for subsequent download or transfer to other devices 110 (e.g., media player/recorders, mobile phones, set-top boxes). The feed can be implemented using known communication protocols (e.g., HTTP, IEEE 802.11) and various known file formats (e.g., RSS, Atom, XML, HTML, JavaScript®).

In some implementations, media files can be distributed through conventional distribution channels, such as website downloading and physical media (e.g., CD ROM, DVD, USB drives).

### Automated Content Creation System

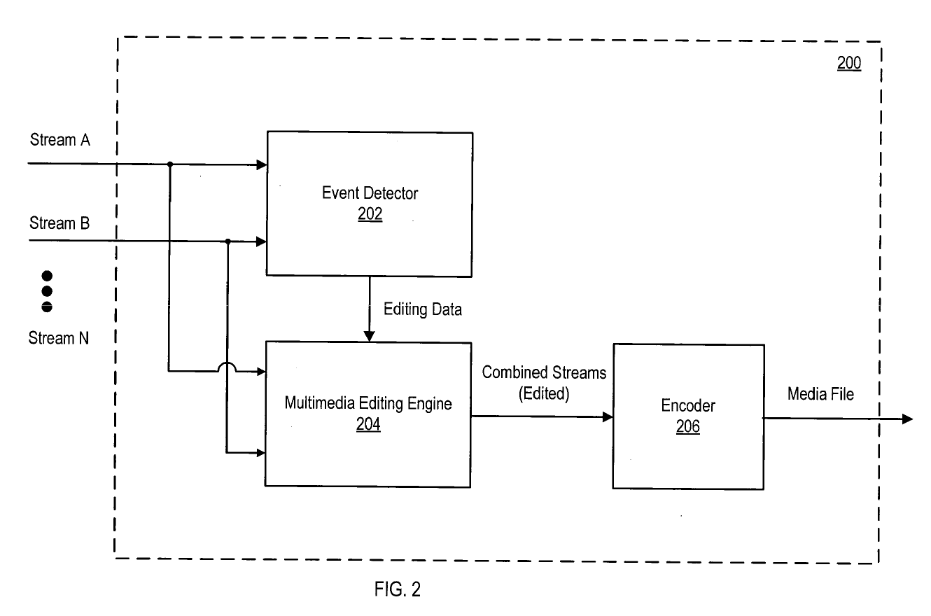

FIG. 2 is a block diagram illustrating an exemplary automated content creation system 200. In some implementations, the system 200 generally includes an event detector 202, a multimedia editing engine 204 and an encoder 206. An advantage of the system 200 is that content can be modified to produce new content without human intervention.

### Event Detector

In some implementations, the event detector 202 receives one or more content streams from a capture system. The content streams can include content (e.g., video, audio, graphics) and metadata associated with the content that can be processed by the event detector 202 to detect events that can be used to apply operations to the content streams. In the example shown, the event detector 202 receives Stream A and Stream B from the capture system 102. In some implementations as discussed below, the event trigger is independent of the individual content streams, and as such, the receipt of the content streams by the event detector 202 is application specific.

The event detector 202 detects trigger events that can be used to determine when to apply operations to one or more of the content streams and which operations to apply. Trigger events can be associated with an application, such as a slide change or long pause before a slide change, a content type or other content characteristic, or other input (e.g., environment input such as provided by a pointing device). For example, a content stream (e.g., Stream B) output by the application 114 can be shown as background (e.g., full screen mode) with a small picture in picture (PIP) window overlying the background for showing the video camera output (e.g., Stream A). If a slide in Stream B does not change (e.g., the “trigger event”) for a predetermined interval of time (e.g., 15 seconds), then Stream A can be operated on (e.g., scaled to full screen on the display). A virtual zoom (e.g., Ken Burns effect) or other effect can be applied to Stream A for a close-up of the instructor 100 or other object (e.g., an audience member) in the environment (e.g., a classroom, lecture hall, studio).

Other trigger events can be captured (e.g., from the environment) using, for example, the capture system 102, including without limitation, patterns of activity of the instructor 100 giving a presentation and/or of the reaction of an audience watching the presentation. The instructor 100 could make certain gestures, or movements (e.g., captured by the video camera), speak certain words, commands or phrases (e.g., captured by a microphone as an audio snippet) or take long pauses before speaking, all of which can generate events in Stream A that can be used to trigger operations.

In one exemplary scenario, the video of the instructor 100 could be shown in full screen as a default. But if the capture system 102 detects that the instructor has turned his back to the audience to read a slide of the presentation, such action can be detected in the video stream and used to apply one or more operations on Stream A or Stream B, including zooming Stream B so that the slide being read by the instructor 100 is presented to the viewer in full screen.

Audio/video event detections can be performed using known technology, such as Open Source Audio-Visual Speech Recognition (AVSR) software, which is part of the well-known Open Source Computer Vision Library (OpenCV) publicly available from Open Source Technology Group, Inc. (Fremont, Calif.).

In some implementations, the movement of a presentation pointer (e.g., a laser pointer) in the environment can be captured and detected as an event by the event detector 202. The direction of the laser pointer to a slide can indicate that the instructor 100 is talking about a particular area of the slide. Therefore, in one implementation, an operation can be to show the slide to the viewer.

The movement of a laser pointer can be detected in the video stream using AVSR software or other known pattern matching algorithms that can isolate the laser's red dot on a pixel device and track its motion (e.g., centroiding). If a red dot is detected, then slides can be switched or other operations performed on the video or application streams. Alternatively, a laser pointer can emit a signal (e.g., radio frequency, infrared) when activated that can be received by a suitable receiver (e.g., a wireless transceiver) in the capture system 102 and used to initiate one or more operations.

In some implementations, a detection of a change of state in a stream is used to determine what is captured from the stream and presented in the final media file(s) or podcast. In some implementations, a transition to a new slide can cause a switch back from a camera feed of the instructor 100 to a slide. For example, when a new slide is presented by the instructor 100, the application stream containing the slide can be shown first as a default configuration, and then switched to the video stream showing the instructor 100, respectively, after a first predetermined period of time has expired. In other implementations, after a second predetermined interval of time has expired, the streams can be switched back to the default configuration.

In some implementations, processing transitions and/or effects can be added to streams at predetermined time intervals without the use of trigger events, such as adding a transition or graphic to the video stream every few minutes (e.g., every 5 minutes) to create a dynamic presentation.

In some implementations, the capture system 102 includes a video camera that can follow the instructor 100 as he moves about the environment. The cameras could be moved by human operator or automatically using known location detection technology. The camera location information can be used to trigger an operation on a stream and/or determine what is captured and presented in the final media file(s) or podcast.

### Multimedia Editing Engine

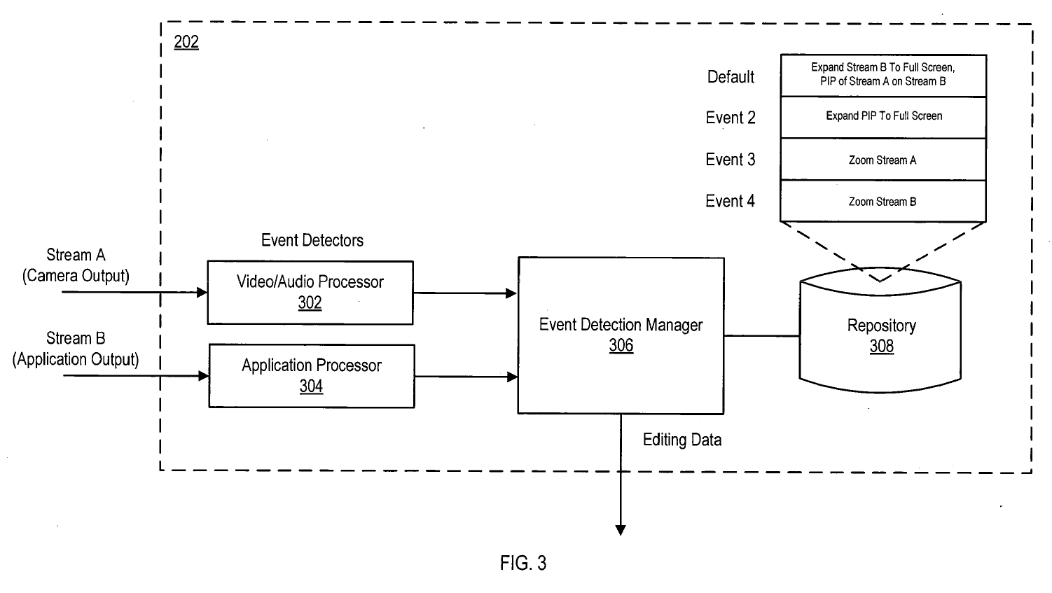

The multimedia editing engine 204 receives edit data output by the event detector 202. The edit data includes one or more edit scripts which contain instructions for execution by the multimedia editing engine 204 to automatically edit one or more content streams in accordance with the instructions. Edit data is described in reference to FIG. 3.

In some implementation, the multimedia editing engine 204 can be a software application that communicates with application programming interfaces (APIs) of well-known video editing applications to apply transitions and/or effects to video streams, audio streams and graphics. For example, the Final Cut Pro® XML Interchange Format provides extensive access to the contents of projects created using Final Cut Pro®. Final Cut Pro® is a professional video editing application developed by Apple Computer, Inc. Such contents include edits and transitions, effects, layer-compositing information, and organizational structures. Final Cut Pro® information can be shared with other applications or systems that support Extensible Markup Language (XML), including nonlinear editors, asset management systems, database systems, and broadcast servers. The multimedia editing engine 204 can exchange documents with Keynote® presentation software, using the Keynote® XML File Format (APXL).

After the streams are edited in accordance with instructions in the edit script provided by the event detector 202, the streams can be combined or mixed together and sent to an encoder 206, which encodes the stream into a format suitable for digital distribution. For example, the streams can be formatted into a multimedia file, such as a QuickTime® movie, XML files, or any other multimedia format. In addition, the files can be compressed by the encoder 206 using well-known compression algorithms (e.g., MPEG).

### Event Detector Components

FIG. 3 is a block diagram illustrating an exemplary event detector 202. In some implementations, the event detector 202 includes event detectors 302 and 304, an event detection manager 306 and a repository 308 for storing edits scripts. In some implementations, the event detectors 302 and 304 are combined into one detector.

In the example shown, a video/audio processor 302 detects events from Stream A. The processor 302 can include image processing software and/or hardware for pattern matching and speech recognition. The image processing can detect patterns of activity by the instructor 100, which are captured by the video camera. Such patterns can include movements or gestures, such as the instructor 100 turning his back to the audience. The processor 302 can also include audio processing software and/or hardware, such as a speech recognition engine that can detect certain key words, commands or phrases. For example, the word “next” when spoken by the instructor 100 can be detected by the speech recognition engine as a slide change event which could initiate a processing operation. The speech recognition engine can be implemented using known speech recognition technologies, including but not limited to: hidden Markov models, dynamic programming, neural networks and knowledge-based learning, etc.

In the example shown, an application processor 304 detects events from Stream B. The processor 304 can include software and/or hardware for processing application output (e.g., files, metadata). For example, the application processor 304 could include a timer or counter for determining how long a particular slide has been displayed. If the display of a slide remains stable for a predetermined time interval, an event is detected that can be used to initiate an operation, such as switching PIP window contents to a full screen display.

In some implementations, the event detection manager 306 is configured to receive outputs from the event detectors 302 and 304 and to generate an index for retrieving edit scripts from the repository 308. The repository 308 can be implemented as a relational database using known database technology (e.g., MySQL®). The repository 308 can store edit scripts that include instructions for performing edits on video/audio streams and/or application streams. The edit script instructions can be formatted to be interpreted by the multimedia editing engine 204. Some example scripts are: “expand Stream B to full screen, PIP of Stream A on Stream B,” “expand PIP to full screen,” “zoom Stream A,” and “zoom Stream B.” At least one edit script can be a default.

In the example shown, the event detection manager 306 aggregates one or more edit scripts retrieved from the repository 308 based on output from the event detectors 302 and 304, and outputs edit data that can be used by the multimedia editing engine 204 to apply one or more operations (i.e., edit) to Stream A and/or Stream B.

### Automated Content Creation Processes

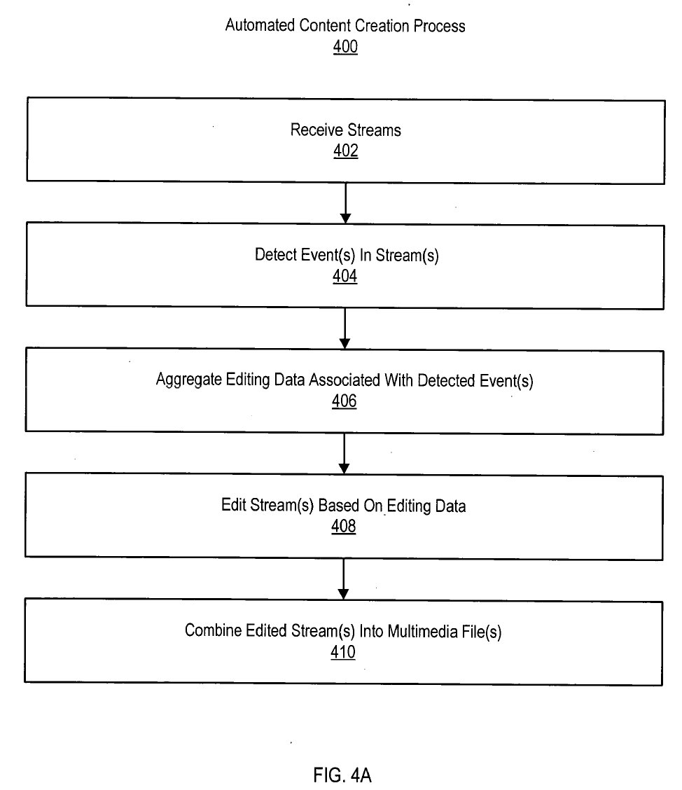

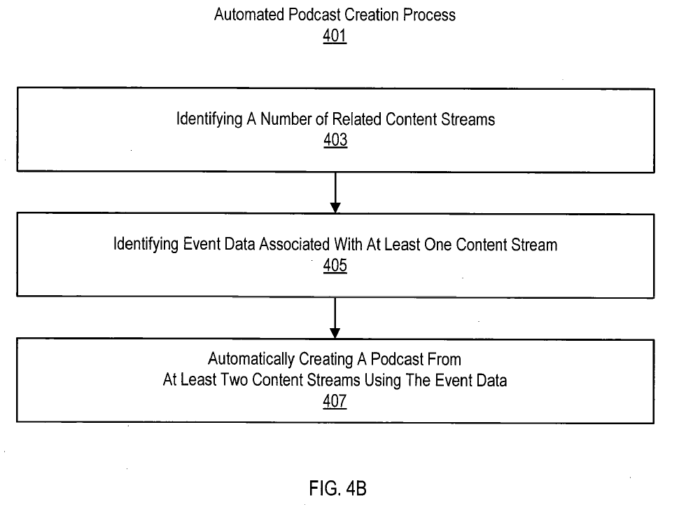

FIG. 4A is a flow diagram of an exemplary automated content creation process 400 performed by the automated content creation system 200. The process 400 begins when one or more streams are received (e.g., by the automated content creation system) (402). One or more events are detected (e.g., by an event detector) in, for example, one or more of the streams (404). Edit data associated with the detected events is aggregated (e.g., by an event detection manager) (406). Edit data can include edit scripts as described in reference to FIG. 3. One or more of the streams is edited based on the edit data (e.g., by a multimedia editing engine) (408) and combined or mixed along with one or more other streams into one or more multimedia files (410).

FIG. 4B is a flow diagram of an exemplary automated podcast creation process 401 performed by the automated content creation system 200. The process 401 begins by identifying a number of related content streams (e.g., identified by the automated content creation system) (403). Event data associated with at least one content stream is identified (e.g., by an event detector) (405). A podcast is automatically created from at least two content streams using the event data (407).

### Syndication Server Architecture

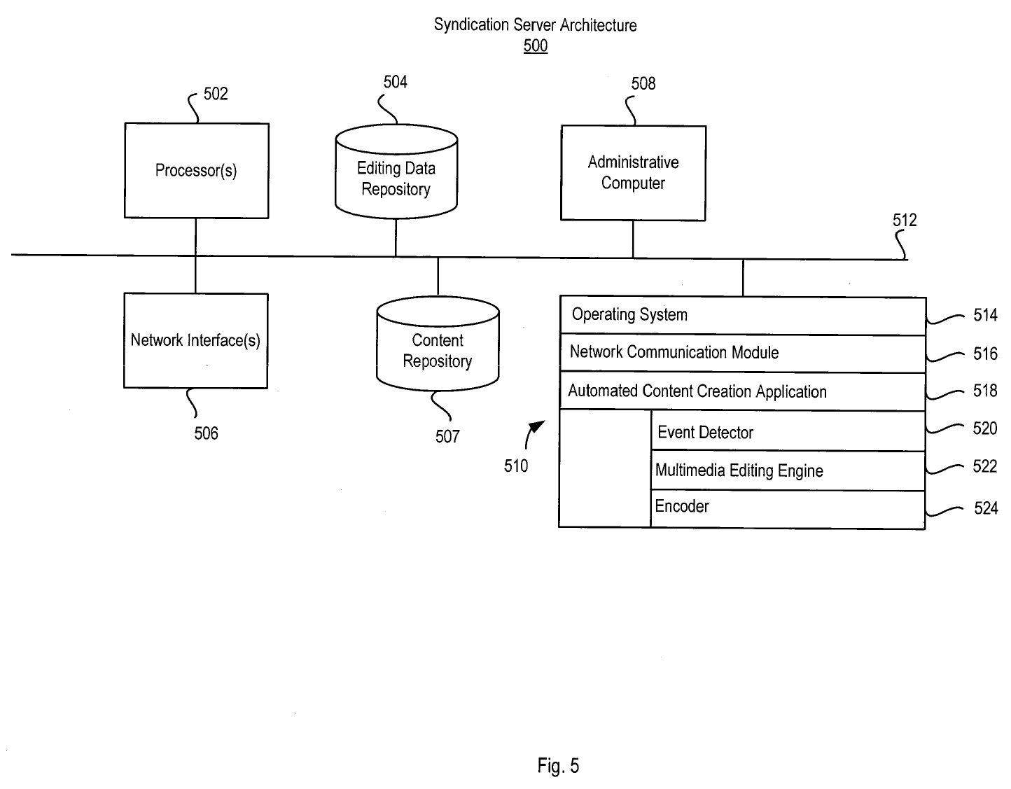

FIG. 5 is a block diagram of an exemplary syndication server architecture 500. Other architectures are possible, including architectures with more or fewer components. In some implementations, the architecture 500 includes one or more processors 502 (e.g., dual-core Intel® Xeon® Processors), an edit data repository 504, one or more network interfaces 506, a content repository 507, an optional administrative computer 508 and one or more computer-readable mediums 510 (e.g., RAM, ROM, SDRAM, hard disk, optical disk, flash memory, SAN, etc.). These components can exchange communications and data over one or more communication channels 512 (e.g., Ethernet, Enterprise Service Bus, PCI, PCI-Express, etc.), which can include various known network devices (e.g., routers, hubs, gateways, buses) and utilize software (e.g., middleware) for facilitating the transfer of data and control signals between devices.

The term “computer-readable medium” refers to any medium that participates in providing instructions to a processor 502 for execution, including without limitation, non-volatile media (e.g., optical or magnetic disks), volatile media (e.g., memory) and transmission media. Transmission media includes, without limitation, coaxial cables, copper wire and fiber optics. Transmission media can also take the form of acoustic, light or radio frequency waves.

The computer-readable medium 510 further includes an operating system 514 (e.g., Mac OS® server, Windows® NT server), a network communication module 516 and an automated content creation application 518. The operating system 514 can be multi-user, multiprocessing, multitasking, multithreading, real time, etc. The operating system 514 performs basic tasks, including but not limited to: recognizing input from and providing output to the administrator computer 508; keeping track and managing files and directories on computer-readable mediums 510 (e.g., memory or a storage device); controlling peripheral devices (e.g., repositories 504, 507); and managing traffic on the one or more communication channels 512. The network communications module 516 includes various components for establishing and maintaining network connections (e.g., software for implementing communication protocols, such as TCP/IP, HTTP, etc.).

The repository 504 is used to store editing scripts and other information that can be used for operations. The repository 507 is used to store or buffer the content streams during operations and to store media files or podcasts to be distributed or streamed to users.

The automated content creation application 518 includes an event detector 520, a multimedia editing engine 522 and an encoder. Each of these components were previously described in reference to FIG. 3.

The architecture 500 is one example of a suitable architecture for hosting an automated content creation application. Other architectures are possible, which can include more or fewer components. For example, the edit data repository 504 and the content repository 507 can be the same storage device or separate storage devices. The components of architecture 500 can be located in the same facility or distributed among several facilities. The architecture 500 can be implemented in a parallel processing or peer-to-peer infrastructure or on a single device with one or more processors. The automated content creation application 518 can include multiple software components or it can be a single body of code. Some or all of the functionality of the application 518 can be provided as a service to uses or subscribers over a network. In such a case, these entities may need to install client applications. Some or all of the functionality of the application 518 can be provided as part of a syndication service and can use information gathered by the service to create content, as described in reference to FIGS. 1-4.

### Exemplary Processing Operation

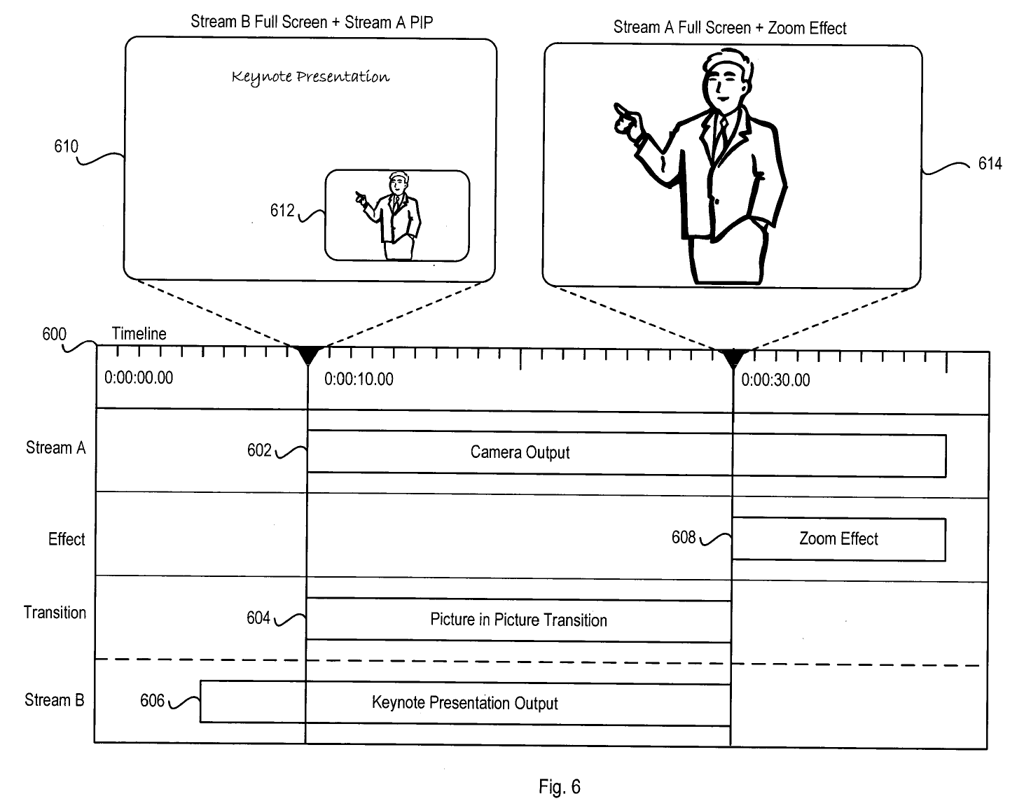

FIG. 6 illustrates a processing operation for generating new content in response to a trigger event. A timeline 600 illustrates first and second operations. In some implementations, the first processing operation includes generating a first display 610 including a presentation (e.g., Keynote®) as a background and video camera output in a PIP window 612 overlying the background. The second processing operation includes generating a second display 614, where the content displayed in the PIP window 612 is expanded to full screen in response to a trigger event.

The timeline 600 is presented in a common format used by video editing applications. The top of the timeline 600 includes a time ruler to read off elapsed running time of the multimedia media file. The first lane includes a horizontal bar representing camera output 602, the second lane includes a horizontal bar representing a zoom effect 608 occurring at desired time based on a first detected event, the third lane includes a horizontal bar representing a PIP transition occurring at desired time determined by a second detected event and the fourth lane includes a horizontal bar representing application output 606. Other lanes are possible, such as lanes for video audio, soundtracks and sound effects. The timeline 600 is only a brief segment of a media file. In practice, media files could be much longer.

In the example shown, a first event occurs at the 10 second mark. At this time, one or more first operations are performed (and in the example shown), the application output 606 is displayed as background and a PIP window 612 is overlaid on the background). The PIP transition 604 starts at the 10 second mark and continues to the second event which occurs at the 30 second mark. The video camera output 602 starts at the 10 second mark and continues through the 30 second mark. The first event could be a default event or it could be based on a new slide being presented. Other events are possible.

At the second event, one or more second operations are performed (and in the example shown, the application output 606 terminates or is minimized and the video camera output 602 is expanded to full screen with a zoom effect 608 applied). The second event could be a slide from, for example, the Keynote® presentation remaining stable (e.g., not changing) for a predetermined time interval (e.g., 15 seconds). Other events for triggering a processing operation are possible.

The implementations described in reference to FIGS. 1-6 provide an advantage of automatically creating new content from streams without human intervention. An automated content creation application can be configured to automatically provide N streams of content and/or metadata to the automated content creation application, and the application will automatically detect events and create new content that includes transitions and/or effects at locations determined by the events. In some implementations, the user can be provided with a user interface element (e.g., a button) for specifying the automatic creation of a podcast. In such a mode, the user prefers to have a podcast created based on edit scripts automatically selected by the content creation application. In other implementations, the user can specify their preferences on which streams to be combined, trigger events and operations. For example, a user can be presented with a user interface that allows the user to create custom edit scripts and to specify trigger events for invoking the custom edit scripts.

The disclosed and other implementations and the functional operations described in this specification can be implemented in digital electronic circuitry, or in computer software, firmware, or hardware, including the structures disclosed in this specification and their structural equivalents, or in combinations of one or more of them. The disclosed and other implementations can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows, can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed implementations can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed implementations can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Various modifications may be made to the disclosed implementations and still be within the scope of the following claims.

What is claimed is:

1. A method, comprising:
receiving a number of content streams and event data; and
automatically performing an operation on a content stream using the event data.

2. The method of claim 1, further comprising:
combining the number of content streams into a media file; and
transmitting the media file over a network or bus.

3. The method of claim 1, wherein distributing the media file further comprises:
broadcasting the media file over a network.

4. The method of claim 1, wherein performing an operation further comprises:
automatically determining a location in a content stream where the operation will be performed based on the event data; and
automatically performing the operation on the content stream at the determined location.

5. The method of claim 4, further comprising:
automatically determining a type of operation to be performed on the content stream based on the event data; and
automatically performing the determined operation on the content stream at the determined location.

6. The method of claim 1, further comprising:
detecting the event data in one or more of the content streams; and
determining an operation to perform on the content stream based on the event data.

7. The method of claim 1, wherein determining an operation further comprises:
matching an edit script with the event data; and
performing the edit script on the content stream.

8. The method of claim 1, wherein a first content stream is video camera output and a second content stream is an application output, and performing the operation further comprises:
inserting a transition or effect into at least one of the first and second content streams.

9. A method, comprising:
receiving content streams;
detecting an event in one or more of the content streams;
aggregating edit data associated with the detected event;
applying the edit data to at least one content stream; and
combining the content streams into one or more media files.

10. A method, comprising:
processing a first content stream for display as a background;
processing a second content stream for display in a picture in picture window overlying the background; and
switching the first and second content streams in response to event data associated with the first or second content streams.

11. The method of claim 10, wherein switching further comprises:
determining a time to switch the first and second content streams from the event data.

12. The method of claim 10, wherein switching further comprises:
expanding the second content stream to a full screen display; and
applying an effect to the second content stream.

13. The method of claim 10, further comprising:
mixing the first and second content streams into a media file; and
broadcasting the media file over a network.

14. The method of claim 10, wherein the first content stream is an application output stream and the event data is detected in the application output.

15. The method of claim 14, wherein the event data is from a group of event data consisting of a slide change, a time duration between slides and metadata associated with the application.

16. The method of claim 10, wherein the second content stream is video camera output and the event data is detected in the video camera output.

17. The method of claim 16, wherein the event data is from a group of event data consisting of a pattern of activity associated with an object in the video camera output, an audio snippet, a spoken command and presentation pointer output.

18. A system, comprising;
a capture system configurable for capturing one or more content streams and event data; and
a processor coupled to the capture system for automatically applying an operation on a content stream based on the event data.

19. The method of claim 18, wherein the processor is configurable for:
automatically determining a location in the content stream where the operation will be performed based on the event data; and
automatically performing the operation on the content stream at the determined location.

20. The method of claim 19, wherein the processor is configurable for:
automatically determining a type of operation to be performed on the content stream based on the event data; and
automatically performing the determined operation on the content stream at the determined location.

21. A computer-readable medium having instructions stored thereon, which, when executed by a processor, causes the processor to perform operations comprising:
receiving a number of content streams and event data; and
automatically performing an operation on a content stream using the event data.

22. A computer-readable medium having instructions stored thereon, which, when executed by a processor, causes the processor to perform operations comprising:
receiving content streams;
detecting an event in or associated with one or more of the content streams;
aggregating edit data associated with the detected event;
applying the edit data to at least one content stream; and
combining the content streams into one or more media files.

23. A computer-readable medium having instructions stored thereon, which, when executed by a processor, causes the processor to perform operations comprising:
processing a first content stream for display as a background;
processing a second content stream for display in a picture in picture window overlying the background; and
switching the first and second content streams in response to event data associated with the first or second content streams.

24. A method, comprising:
receiving a video or audio output;
receiving an application output; and
automatically performing an operation on at least one of the outputs using event data associated with one or more of the outputs.

25. A system, comprising:
a capture system operable for receiving a video or audio output and an application output; and
a processor coupled to the capture system and operable for automatically performing an operation on at least one of the outputs using event data associated with one or more of the outputs.

26. A method of creating a podcast, comprising:
receiving a number of content streams; and
automatically generating a podcast from two or more of the content streams based on event data associated with at least one of the content streams.

27. The method of claim 26, further comprising:
detecting event data in one or more of the content streams.

28. The method of claim 27, further comprising:
retrieving an edit script based on the detected event data; and
applying the edit script to one or more of the content streams to generate the podcast.

29. The method of claim 28, wherein applying the edit script further comprises:
applying a transition operation to one or more of the content streams

30. A computer-readable medium having instructions stored thereon, which, when executed by a processor, causes the processor to perform operations, comprising:
providing a user interface for presentation on a display device;
receiving first input through the user interface specifying the automatic creation of a podcast; and
automatically creating the podcast in response to the first input.

31. The computer-readable medium of claim 30, further comprising:
providing for presentation on the user interface representations of content streams;
receiving second input through the user interface specifying two or more content streams for use in creating the podcast; and
automatically creating the podcast based on the two or more specified streams.

32. A method, comprising:
providing a user interface for presentation on a display device;
receiving first input through the user interface specifying the automatic creation of a podcast; and
automatically creating the podcast in response to the first input.

33. The method of claim 32, further comprising:
providing for presentation on the user interface representations of content streams;
receiving second input through the user interface specifying two or more content streams for use in creating the podcast; and
automatically creating the podcast based on the two or more specified streams.

34. A method, comprising:
identifying a number of related content streams;
identifying event data associated with at least one content stream; and
automatically creating a podcast from at least two content streams using the event data.
